(19) United States
(12) Patent Application Publication
(10) Pub. No.: US 2017/0196767 A1
(43) Pub. Date: Jul. 13, 2017

(54) EMERGENCY MEDICAL GLOVES

(71) Applicants: Sanjuana Cox, Long Beach, CA (US); Deborah Cox, Long Beach, CA (US)

(72) Inventors: Sanjuana Cox, Long Beach, CA (US); Deborah Cox, Long Beach, CA (US)

(21) Appl. No.: 14/992,530

(22) Filed: Jan. 11, 2016

(51) Int. Cl. A61H 31/00

(52) U.S. Cl. CPC A61H 31/005

(57) ABSTRACT

A pair of gloves for performing cardiopulmonary resuscitation (CPR) is disclosed. The left hand glove comprises a sensor detector in form of heart shape, or the like. The right hand glove is provided with green and red light sensors in the shape of arrows. In use, the left hand glove is placed over a patient's heart for detecting heartbeats wherein the right hand glove's green light sensor indicates when it's time to blow into the patient's lungs and red light sensor indicates when it's time to push down and pump the patient's chest.

### FIELD OF THE INVENTION

The present invention relates to a medical assistive device, which is an emergency glove. This device is applicable to the general field of the emergency equipment technology. More specifically, the invention is a cardiopulmonary resuscitation gloves.

### BACKGROUND OF THE INVENTION

Cardiopulmonary resuscitation, commonly known as CPR, is an emergency procedure performed in an effort to manually preserve intact brain function until further measures are taken to restore spontaneous blood circulation and breathing in a person who is in cardiac arrest. It is indicated in those who are unresponsive with no breathing or abnormal breathing, for example, agonal respirations.

According to the International Liaison Committee on the Resuscitation guidelines, CPR involves chest compressions at least 5 cm (2 in) deep and at a rate of at least 100 per minute in an effort to create artificial circulation by manually pumping blood through the heart and thus the body. The rescuer may also provide breaths by either exhaling into the subject's mouth or nose or using a device that pushes air into the subject's lungs. This process of externally providing ventilation is termed artificial respiration. Current recommendations place emphasis on high-quality chest compressions over artificial respiration; a simplified CPR method involving chest compressions only is recommended for untrained rescuers.

CPR alone is unlikely to restart the heart. Its main purpose is to restore partial flow of oxygenated blood to the brain and heart. The objective is to delay tissue death and to extend the brief window of opportunity for a successful resuscitation without permanent brain damage. Administration of an electric shock to the subject's heart, termed defibrillation, is usually needed in order to restore a viable or “perfusing” heart rhythm. Defibrillation is effective only for certain heart rhythms, namely ventricular fibrillation or pulseless ventricular tachycardia, rather than asystole or pulseless electrical activity. CPR may succeed in inducing a heart rhythm that may be shock-able. In general, CPR is continued until the patient has a return of spontaneous circulation (ROSC) or is declared dead.

CPR is indicated for any person unresponsive with no breathing or breathing only in occasional agonal gasps, as it is most likely that they are in cardiac arrest. If a person still has a pulse but is not breathing (respiratory arrest) artificial respirations may be more appropriate, but, due to the difficulty people have in accurately assessing the presence or absence of a pulse, CPR guidelines recommend that lay persons should not be instructed to check the pulse, while giving healthcare professionals the option to check a pulse. In those with cardiac arrest due to trauma, CPR is considered futile but still recommended. Correcting the underlying cause such as a pneumothorax or pericardial tamponade may help.

With the accelerated pace of life, increasing pressure of modern life, there are a lot of people die each year with acute myocardial infarction. Patients with cardiac arrest, when, if they can get timely, high-quality CPR rescue, could save the lives of many patients. But even trained personnel performing chest compressions when pressed cannot be a good grasp of the intensity and time intervals. So, often the help of the professional tool chest compressions is required. But professional tool chest compressions are often bulky and inconvenient to carry. Therefore, there a need exists for a convenient respiratory system which provides a cardiopulmonary resuscitation; such that it can be helpful to the patients in case of emergency. The present invention fulfills this need.

### SUMMARY OF THE INVENTION

A pair of gloves for performing cardiopulmonary resuscitation (CPR) is disclosed. The left hand glove comprises a sensor detector in form of heart shape, or the like. The right hand glove is provided with green and red light sensors in the shape of arrows. In use, the left hand glove is placed over a patient's heart for detecting heartbeats wherein the right hand glove's green light sensor indicates when it's time to blow into the patient's lungs and red light sensor indicates when it's time to push down and pump the patient's chest.

It is an object of the present invention to provide a pair of first aid gloves that can be used to perform high-quality cardiopulmonary resuscitation even without highly trained non-medical personnel in the event of unforeseen circumstances.

In yet another aspect of the present invention that the pair of gloves are portable a n d designed to provide easy handling and are easy to operate.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a graphical illustration of the glove for the left hand, according to a preferred embodiment of the present invention; and

FIG. 2 is a graphical illustration of the glove for the right hand, according to a preferred embodiment of the present invention.

### DETAIL DESCRIPTION OF THE INVENTION

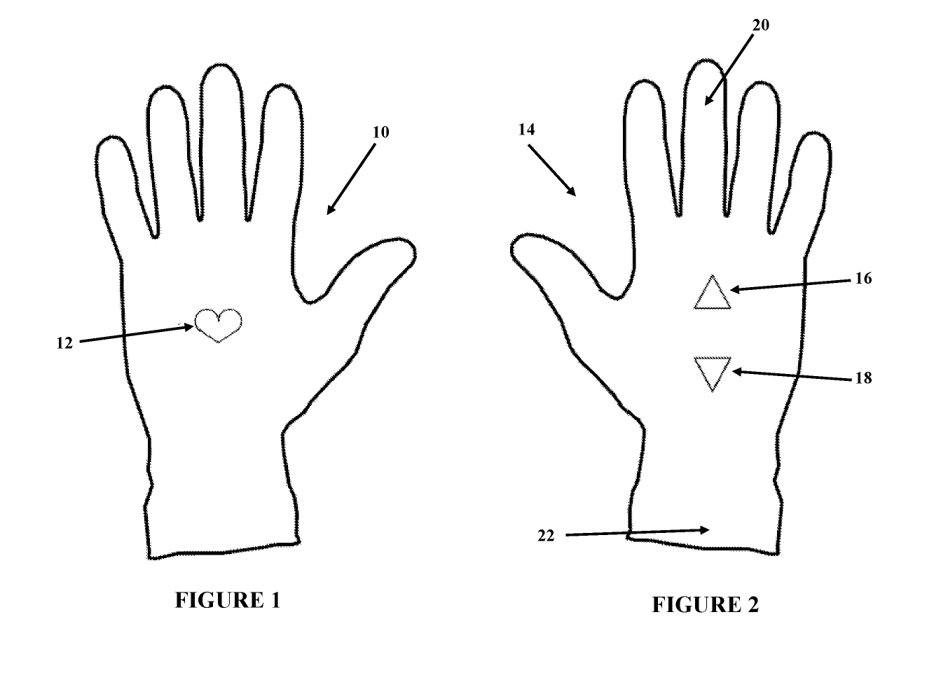

Referring now to FIG. 1, there is shown and illustrated a left hand glove 10 in accordance with the present invention. The 1 e ft hand glove 10 houses a heart shaped sensor detector 12. The heart shaped sensor detector 12 is positioned in the right place in the user's hand, specifically at the top center of left hand glove 10.

Referring now to FIG. 2, there is shown and illustrated a right hand glove 14 in accordance with the present invention. The right hand glove 14 houses two sensors; more specifically, a green light sensor 16 located at a top end and a red light sensor 18 located towards the bottom of the glove. The two sensors 16 and 18, respectively on the right hand glove 14 are in the shape of a triangle and located in the middle of right hand glove 14. The green light sensor is facing the index finger 20, and the red light sensor is facing towards the wrist 22. The green light sensor 16 will turn green when it's time to blow into a patient's lungs (not shown). The red light sensor 18 will turn red when it's time to push down and start pumping on the patient's chest (not shown).

The above described pair of gloves 10 and 14, respectively, when used together are able to perform cardiopulmonary resuscitation (CPR), by allowing a rescuer to combine artificial, emergency ventilation of a patient's lungs with cardiopulmonary resuscitation (CPR) type chest compressions. The cardiopulmonary resuscitation (CPR) is administered when a patient stops breathing and the patient's heart stops beating, due to sudden cardiac arrest or the like. Once the rescuer has performed the correct amount of pumping, the green light sensor 16 will turn on to intimate that it's the time to blow into the lungs. The process lasts for at least a minute or longer, if the patient's condition gets worst. Once the pumping process attains a frequency of 100/minutes, the red light sensor 18 will turn to red. In accordance with the invention, the pair of gloves, 10 and 14 respectively, are made from a non-latex material, are easy to carry, and easy to operate, thereby greatly improving the success rate of cardiopulmonary resuscitation, and thus maximum rescue to the patient's life.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A medical emergency glove for performing CPR on a patient in cardiac arrest, comprising:
a left hand glove housing a single sensor for placement over a patient's heart for detecting heartbeats; and
a right hand glove housing a first sensor and a second sensor, wherein said first sensor indicates when it's time to blow into the patient's lungs and said second sensor indicates when it's time to push down and pump the patient's chest.

2. The medical emergency glove according to claim 1, wherein said right hand glove first sensor indicates with a green light.

3. The medical emergency glove according to claim 1, wherein said right hand glove second sensor indicates with a red light.

4. The medical emergency glove according to claim 1, wherein said right hand glove first sensor is in a shape of a triangle and located in a middle of said right hand glove facing an index finger.

5. The medical emergency glove according to claim 1, wherein said right hand glove second sensor is in a shape of a triangle and located in a middle of said right hand glove facing a wrist.

6. The medical emergency glove according to claim 1, wherein said left hand glove sensor is in a shape of a heart and located top center of said left hand glove.

7. The medical emergency glove according to claim 1, wherein said first sensor turns on after said second sensor indicates a correct amount of chest pumping.

8. The medical emergency glove according to claim 1, wherein said left and right gloves are made from a non-latex material.
